(19) United States
(12) Patent Application Publication
(10) Pub. No.: US 2026/0120271 A1
(43) Pub. Date: Apr. 30, 2026

(54) ANOMALY DETECTION DEVICE AND ANOMALY DETECTION METHOD

(71) Applicant: Mitsubishi Electric Corporation, Tokyo (JP)

(72) Inventors: Toru AOKI, Tokyo (JP); Teng-Yok LEE, Tokyo (JP); Akira MINEZAWA, Tokyo (JP)

(73) Assignee: Mitsubishi Electric Corporation, Tokyo (JP)

(21) Appl. No.: 19/432,581

(22) Filed: Dec. 24, 2025

Related U.S. Application Data
(63) Continuation of application No. PCT/JP2023/029012, filed on Aug. 9, 2023.

(51) Int. Cl. G06T 7/00; G06T 7/11; G06V 10/77

(52) U.S. Cl. CPC G06T 7/001; G06T 7/11; G06V 10/7715; G06T 2207/20084; G06T 2207/30108

(57) ABSTRACT

An anomaly detection device includes: an extraction unit to generate a first feature vector set including feature vectors of a plurality of partial regions of an inspection target image as elements; a conversion unit to convert the first feature vector set into a second feature vector set that is the same feature space as that of a normal feature vector set; a first calculation unit to calculate a normal distance per corresponding set element between the normal feature vector group set and the second feature vector set; a second calculation unit to calculate an anomalous distance per corresponding set element between an anomalous feature vector group set and the second feature vector set; and a determination unit to determine whether each element of a set corresponding to the inspection target object image is normal on the basis of the normal and anomalous distance sets.

### CROSS REFERENCE TO RELATED APPLICATION

This application is a Continuation of PCT International Application No. PCT/JP2023/029012, filed on August 9, 2023, which is hereby expressly incorporated by reference into the present application.

### TECHNICAL FIELD

The present disclosure relates to an anomaly detection device and an anomaly detection method.

### BACKGROUND ART

In recent years, automation of appearance inspection of products is advancing. For example, Patent Literature 1 describes an anomaly determination method of automatically determining an anomalous product based on the appearance of an inspection target product. For this method, a normal product learning model is used, which is generated by machine learning using a plurality of normal image data items and is constructed in feature space in which feature amounts of the normal image data are modeled by a multivariate normal distribution. Identification information for identifying whether a product is normal or anomalous is determined on the basis of an output result obtained by inputting known normal image data and known anomalous image data to the normal product learning model. Whether an inspection target product is normal or anomalous is identified on the basis of the identification information, for the output result obtained by inputting image data of an inspection target product to the normal product learning model.

### CITATION LIST

### PATENT LITERATURE

### Patent Literature 1: JP 2021-174456 A

### SUMMARY OF INVENTION

### TECHNICAL PROBLEM

However, a conventional anomaly detection method has a problem that an anomaly of an inspection target product is detected on the basis of a feature amount extracted collectively from the entire image, and therefore it is not possible to specify at which position of an inspection target image obtained by photographing the inspection target product the anomaly is occurring.

The present disclosure solves the above problem, and an object of the present disclosure is to provide an anomaly detection device that can specify at which position of an inspection target image obtained by photographing an inspection target object an anomaly is occurring.

### SOLUTION TO PROBLEM

An anomaly detection device according to the present disclosure includes processing circuitry to extract a first inspection target feature amount vector of each of a plurality of partial regions, and generate a first inspection target feature amount vector set including the first inspection target feature amount vector as an element, the plurality of partial regions partitioning an inspection target object image obtained by photographing an inspection target object; to convert the first inspection target feature amount vector set into a second inspection target feature amount vector set that is same feature space as feature space of a feature amount vector set of an inspection target object in a normal state; to calculate a normal distance per corresponding set element between a normal feature amount vector group set and the second inspection target feature amount vector set, and generate a normal distance set including a normal distance as an element, the normal feature amount vector group set being obtained by collecting a plurality of normal feature amount vector groups for all partial regions, and the plurality of normal feature amount vector groups being calculated for partial regions at an identical position in all normal object images among a plurality of partial regions partitioning a normal object image obtained by photographing the inspection target object in the normal state; to calculate an anomalous distance per corresponding set element between an anomalous feature amount vector group set and the second inspection target feature amount vector set, and generate an anomalous distance set including an anomalous distance as an element, the anomalous feature amount vector group set being obtained by collecting a plurality of anomalous feature amount vector groups for all partial regions, and the plurality of anomalous feature amount vector groups being calculated for partial regions at an identical position in all anomalous object images among a plurality of partial regions partitioning an anomalous object image obtained by photographing an inspection target object in an anomalous state; to determine whether each element of a set corresponding to the inspection target object image is normal or anomalous on a basis of the normal distance set and the anomalous distance set; to acquire a normal object image group, and extract a first normal feature amount vector group set, the normal object image group including a plurality of the normal object images as elements, and the first normal feature amount vector group set being obtained by collecting for all of the partial regions the plurality of normal feature amount vector groups calculated for the partial regions at the identical position in all of the normal object images among the plurality of partial regions partitioning the normal object image; to calculate a conversion processing matrix of the feature space using the first normal feature amount vector group set per partial region of the normal object image, and generate a conversion processing matrix set including a plurality of the conversion processing matrices as elements; to perform conversion using the conversion processing matrix set into a normal feature amount vector set that is same feature space as feature space of the first normal feature amount vector group set and is used to calculate the normal distance; to acquire an anomalous object image group, and extract a first anomalous feature amount vector group set, the anomalous object image group including a plurality of the anomalous object images as elements, and the first anomalous feature amount vector group set being obtained by collecting for all of the partial regions the plurality of anomalous feature amount vector groups calculated for the partial regions at the identical position in all of the anomalous object images among the plurality of partial regions partitioning the anomalous object image; and to perform conversion using the conversion processing matrix set into an anomalous feature amount vector set that is same feature space as feature space of the first anomalous feature amount vector group set and is used to calculate the anomalous distance.

### ADVANTAGEOUS EFFECTS OF INVENTION

According to the present disclosure, a normal distance is calculated per corresponding set element between an inspection target feature amount vector set including, as elements, feature amount vectors of partial regions partitioning into a plurality of regions an inspection target image obtained by photographing an inspection target object, and a normal feature amount vector group set including, as elements, feature amount vectors of partial regions partitioning into a plurality of regions a normal object image obtained by photographing an inspection target object in a normal state. An anomalous distance is calculated per corresponding set element between an inspection target feature amount vector set, and an anomalous feature amount vector group set including, as elements, feature amount vectors of partial regions partitioning into a plurality of regions an anomalous object image obtained by photographing an inspection target object in an anomalous state. Whether the inspection target object is normal or anomalous is determined per element of a set corresponding to the inspection target object image on the basis of the normal distance and the anomalous distance.

The elements of the set correspond to the partial regions of the image, and whether or not there is an anomaly can be determined per partial region of the image, so that the anomaly detection device according to the present disclosure can specify at which position of an inspection target image obtained by photographing an inspection target object an anomaly is occurring.

### BRIEF DESCRIPTION OF DRAWINGS

FIG. 1 is a block diagram illustrating a configuration example of an anomaly detection device according to Embodiment 1.

FIG. 2 is a flowchart illustrating learning processing of the anomaly detection device according to Embodiment 1.

FIG. 3 is a schematic view illustrating an outline of learning of a classification task of a neural network that uses a large-scale image data set.

FIG. 4 is a schematic view schematically illustrating extraction processing of a feature amount vector of a feature amount extractor of the neural network.

FIG. 5 is a schematic view illustrating a correspondence relationship between partial regions in one image and a feature amount vector set.

FIG. 6 is a schematic view illustrating a correspondence relationship between a partial region at an identical position in a plurality of images and a feature amount vector group.

FIG. 7 is a flowchart illustrating inspection processing of the anomaly detection device according to Embodiment 1.

FIGS. 8A and 8B are block diagrams illustrating a hardware configuration that implements functions of the anomaly detection device according to Embodiment 1.

### DESCRIPTION OF EMBODIMENTS

Embodiment 1.

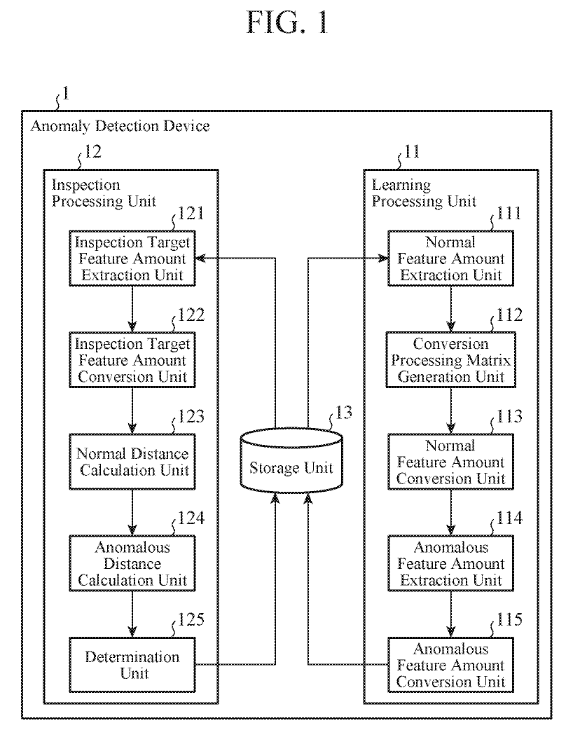

FIG. 1 is a block diagram illustrating a configuration example of an anomaly detection device 1 according to Embodiment 1. In FIG. 1, the anomaly detection device 1 acquires an inspection target object image obtained by photographing an inspection target object, and automatically determines whether the inspection target object is normal or anomalous per partial region obtained by partitioning the inspection target object image into a plurality of regions. Consequently, the anomaly detection device 1 can specify at which position (partial region) of the inspection target image the anomaly is occurring.

A feature amount vector representing a feature of each partial region in an image is used by the anomaly detection device 1 to determine an anomaly of an inspection target object. For example, the anomaly detection device 1 uses a trained neural network to extract a feature amount vector from an image.

The anomaly detection device 1 is implemented using, for example, a tablet terminal, a smartphone, or a notebook-type Personal Computer (PC).

The anomaly detection device 1 may be connected with a camera device unillustrated in FIG. 1 by wire or wirelessly. The camera device is not limited to an externally attached device, and the anomaly detection device 1 may include a built-in camera device. This camera device photographs an inspection target object to inspect the appearance of the inspection target object.

The anomaly detection device 1 may be a component included in a server that can communicate with a terminal device. For example, the terminal device can inspect the appearance of an inspection target object provided in a form of Software as a Service (SaaS). When inspection is performed in the form of SaaS, an inspection application may not be installed in the terminal device. The inspection application is executed on the above server, and the terminal device is provided with measurement result information on a general-purpose Web browser. The inspection application is stored in a storage unit included in the server.

Furthermore, the inspection application may be installed in the terminal device. The terminal device in which the inspection application has been installed can inspect the appearance of an inspection target object when the application is executed.

The anomaly detection device 1 is implemented by a computer including in an arithmetic operation unit and a storage unit. The storage unit is a storage unit 13 in FIG. 1, and is a storage device included in the above computer.

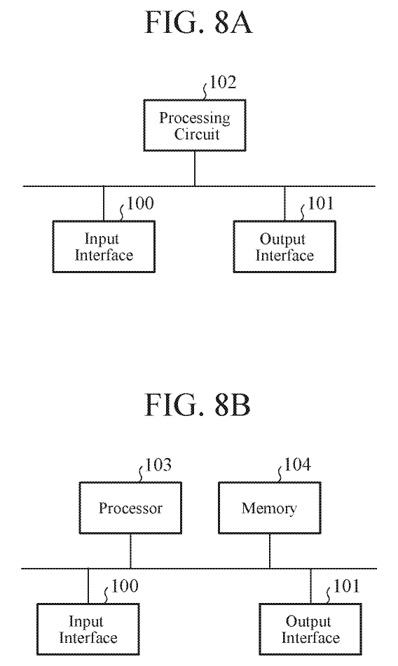

The storage unit 13 includes, for example, a storage such as a Hard Disk Drive (HDD) or a Solid State Drive (SSD), or a memory 104 in FIG. 8B described later. Note that the storage unit 13 may be any storage unit accessible by the anomaly detection device 1, and the storage unit 13 may be provided outside the anomaly detection device 1.

The arithmetic operation unit controls the entire operation of the anomaly detection device 1. The arithmetic operation unit includes a learning processing unit 11 and an inspection processing unit 12. The arithmetic operation unit implements various functions of the learning processing unit 11 and the inspection processing unit 12 by executing the inspection application stored in the storage unit 13.

The learning processing unit 11 includes a normal feature amount extraction unit 111, a conversion processing matrix generation unit 112, a normal feature amount conversion unit 113, an anomalous feature amount extraction unit 114, and an anomalous feature amount conversion unit 115.

The inspection processing unit 12 includes an inspection target feature amount extraction unit 121, an inspection target feature amount conversion unit 122, a normal distance calculation unit 123, an anomalous distance calculation unit 124, and a determination unit 125.

The learning processing unit 11 performs learning processing. During the learning processing, the learning processing unit 11 acquires a plurality of normal object image groups obtained by photographing an inspection target object in a normal state, and one or more anomalous object image groups obtained by photographing an inspection target object in an anomalous state, and generates a conversion processing matrix set, a second normal image feature amount vector group set, and a second anomalous image feature amount vector group set.

The conversion processing matrix set is a set of conversion processing matrices for converting a feature amount in accordance with a distribution of normal object image groups. The second normal image feature amount vector group set is a set of second normal image feature amount vectors representing feature amounts after the conversion processing of the normal object image group. A second anomalous image feature amount vector group set is a set of second anomalous image feature amount vectors representing feature amounts after the conversion processing of the anomalous object image group. The conversion processing matrix set, the second normal image feature amount vector group set, and the second anomalous image feature amount vector group set are stored in the storage unit 13 from the learning processing unit 11.

The inspection processing unit 12 performs inspection processing that is appearance inspection of an inspection target object. When acquiring an inspection target object image obtained by photographing an inspection target object during the inspection processing, the inspection processing unit 12 determines whether the inspection target object in the inspection target object image is normal or anomalous using the conversion processing matrix set, the second normal image feature amount vector group set, and the second anomalous image feature amount vector group set stored in the storage unit 13.

First, learning processing according to Embodiment 1 will be described.

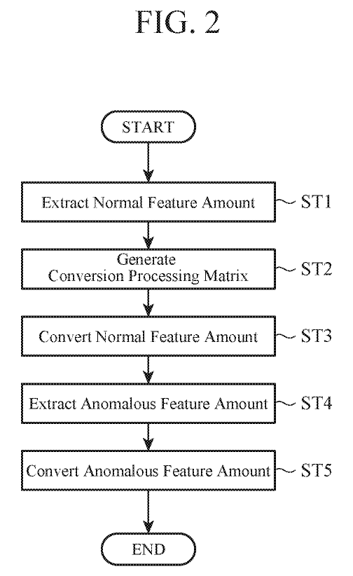

FIG. 2 is a flowchart illustrating the learning processing of the anomaly detection device according to Embodiment 1, and illustrates the learning processing of the learning processing unit 11.

The normal feature amount extraction unit 111 extracts a first normal feature amount vector group set obtained by collecting a plurality of normal feature amount vector groups for all of partial regions (step ST1).

For example, the normal feature amount extraction unit 111 extracts the first normal feature amount vector group set from the normal object image group by training the neural network using a large-scale image data set such as ImageNet, and inputting the normal object image group to a feature amount extractor of this neural network.

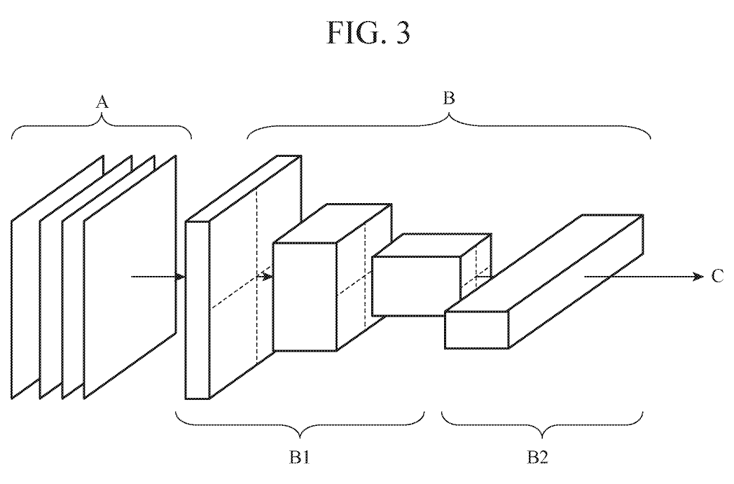

FIG. 3 is a schematic view illustrating the outline of learning of a classification task of a neural network B that uses a large-scale image data set A. The neural network B includes a feature amount extractor B1 and a classifier B2. In step ST1, the normal feature amount extraction unit 111 uses the feature amount extractor B1. The classifier B2 outputs a classification result C.

Each element of a first normal feature amount vector group set corresponds to a partial region obtained by partitioning a normal object image into a plurality of regions, and a first normal feature amount vector group set corresponds to each partial region.

A first normal feature amount vector that is an element of the first normal feature amount vector group is a feature amount vector representing a feature of a partial region in one normal object image included in a normal object image group.

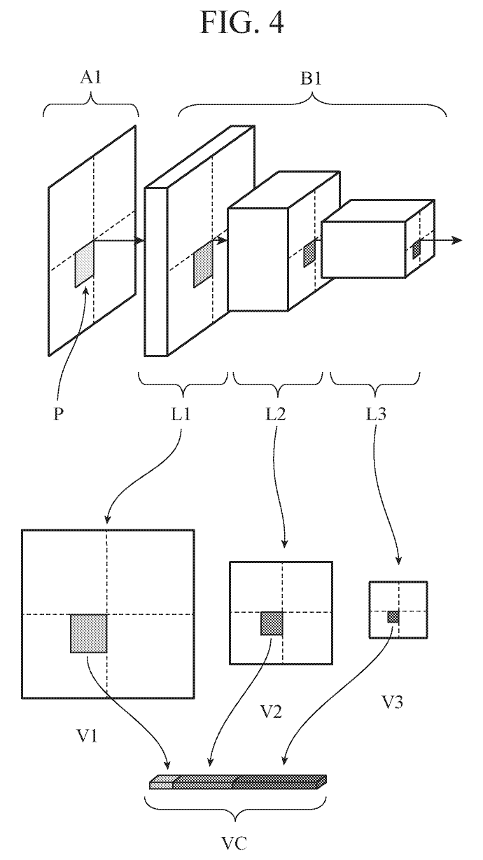

FIG. 4 is a schematic view schematically illustrating extraction processing of a feature amount vector of the feature amount extractor B1 of the neural network. As illustrated in FIG. 4, a normal object image A1 is partitioned into a plurality of partial regions P. The feature amount extractor B1 includes a Convolutional Neural Network (CNN) of a first layer (L1), a second layer (L2), and a third layer (L3), and a feature amount vector representing a feature of a partial region is extracted in each layer. A set of a feature amount vector V1 of the first layer of the partial region P, a feature amount vector V2 of the second layer of the partial region P, and a feature amount vector V3 of the third layer of the partial region P are a first normal feature amount vector VC corresponding to the partial region P.

Note that, although the case where the feature amount extractor B1 is the CNN of the three layers has been described, the feature amount extractor B1 is not limited to the CNN of the three layers as long as the feature amount extractor B1 can extract the feature amount vector of the partial region.

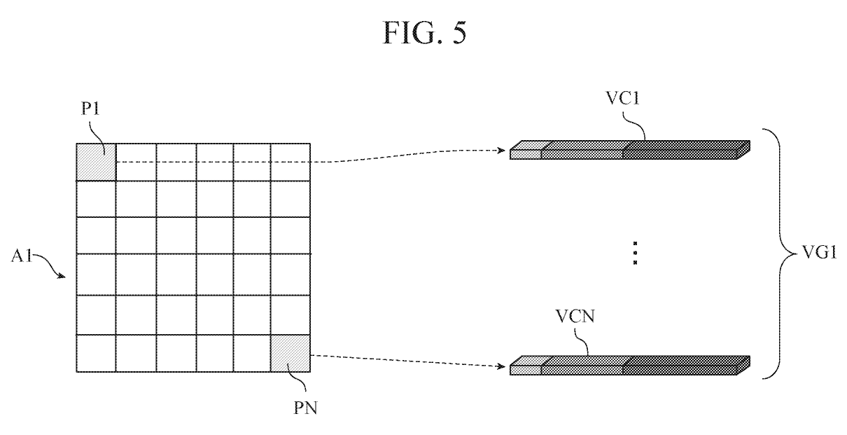

FIG. 5 is a schematic view illustrating a correspondence relationship between partial regions P1 to PN in the one image A1 and a feature amount vector set. As illustrated in FIG. 5, one feature amount vector is calculated from one partial region of the partial regions P1 to PN obtained by partitioning the image A1 into a plurality of regions. A set of feature amount vectors VC1 to VCN of the partial regions P1 to PN are a feature amount vector set VG1.

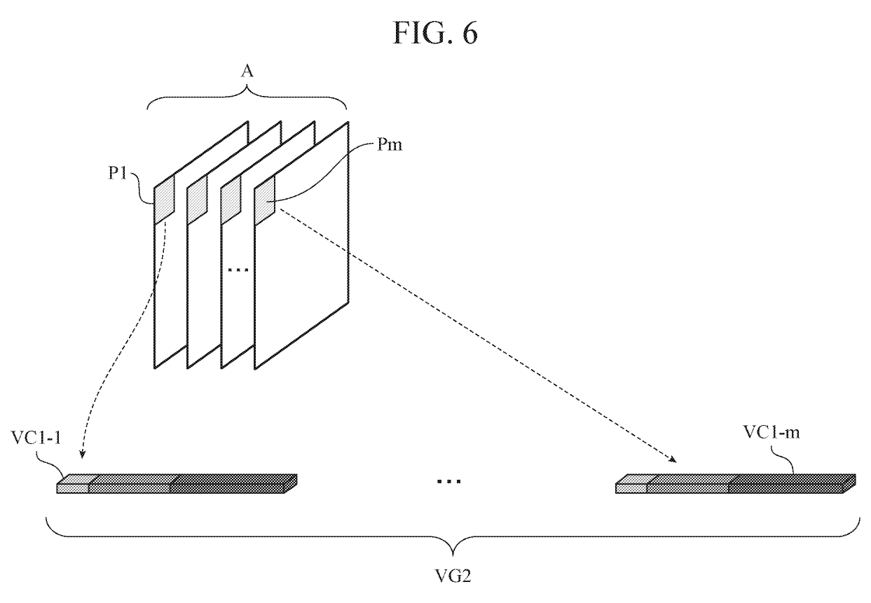

FIG. 6 is a schematic view illustrating a correspondence relationship between the partial region P1 at the identical position in the plurality of images A and a feature amount vector group VG2. As illustrated in FIG. 6, an image group A includes a plurality of images obtained by photographing an identical inspection target object. The image group A is a series of image groups obtained by photographing from the same angle of view, for example, the inspection target product flowing in order on a production line.

The feature amount extractor B1 extracts feature amount vectors VC-1 to VC-m from the partial regions P1 to Pm at the identical position in the image group A. A set of the feature amount vectors VC-1 to VC-m is the feature amount vector group VG2. In FIGS. 5 and 6, a set obtained by collecting for all of the partial regions P1 to PN the feature amount vector group VG2 including a plurality of feature amount vectors VC-1 to VC-m calculated for the partial regions at the identical position P1 to Pm in all images among partial regions obtained by partitioning each image of the image group A into a plurality of regions is a feature amount vector group set.

The conversion processing matrix generation unit 112 calculates a conversion processing matrix of the feature space using the first normal feature amount vector group set per partial region of the normal object image, and generates a conversion processing matrix set including a plurality of the conversion processing matrices as elements (step ST2). For example, the conversion processing matrix generation unit 112 calculates the conversion processing matrix set by performing singular value decomposition on the first normal feature amount vector group set per first normal feature amount vector group that is a set element. The conversion processing matrix that is the element of the conversion processing matrix set is calculated per partial region.

When the number of elements of the first normal feature amount vector is P, and the number of elements of the first normal feature amount vector group is N, P singular values and a singular value decomposition matrix of P rows and P columns can be obtained by singular value decomposition. The conversion processing matrix generation unit 112 takes out higher K singular values of the P singular values, and calculates as a conversion processing matrix a matrix of the P rows and K columns obtained by taking out a column corresponding to the higher K singular values from the singular value matrix. Normally, P represents a value from one hundred to approximately several hundreds. By contrast with this, a value of approximately several tens is used for K. The conversion processing matrix set is stored in the storage unit 13.

The normal feature amount conversion unit 113 performs conversion using the conversion processing matrix set into a normal feature amount vector set that is the same feature space as that of the first normal feature amount vector group set and is used to calculate a normal distance (step ST3). For example, the normal feature amount conversion unit 113 converts the first normal feature amount vector group set per set element using the conversion processing matrix set, and calculates a second normal feature amount vector group set. The second normal feature amount vector group set is stored in the storage unit 13.

The conversion processing matrix is calculated per partial region. A set obtained by collecting conversion processing matrices for all partial regions in one image is a conversion processing matrix set.

Note that one normal feature amount vector is calculated for one partial region of one image.

A normal feature amount vector group includes, as elements, normal feature amount vectors corresponding to partial regions at the identical position in a plurality of images.

Furthermore, the normal feature amount vector group set is obtained by collecting normal feature amount vector groups for all partial regions.

By multiplying the conversion processing matrix corresponding to one partial region in the conversion processing matrix set with the normal feature amount vector group corresponding to the partial region at the identical position, the normal feature amount conversion unit 113 converts feature space from number of images × Pth dimensional vector to number of images × Kth dimensional vector.

The anomalous feature amount extraction unit 114 extracts a first anomalous feature amount vector group set obtained by collecting a plurality of anomalous feature amount vector groups for all of partial regions (step ST4). For example, the anomalous feature amount extraction unit 114 extracts the first anomalous feature amount vector group set by inputting the anomalous object image group to the feature amount extractor B1 of the trained neural network.

The anomalous feature amount conversion unit 115 performs conversion using the conversion processing matrix set into an anomalous feature amount vector set that is the same feature space as that of the first anomalous feature amount vector group set and is used to calculate an anomalous distance (step ST5). For example, the anomalous feature amount conversion unit 115 converts the first anomalous feature amount vector group set per set element using the conversion processing matrix set, and calculates a second anomalous feature amount vector group set. The second anomalous feature amount vector group set is stored in the storage unit 13.

Note that a conversion processing matrix calculated using a normal feature amount vector is also used to convert an anomalous feature amount vector, and thereby the normal feature amount vector and the anomalous feature amount vector are both converted into the same feature space.

Next, an anomaly detection method according to Embodiment 1 will be described.

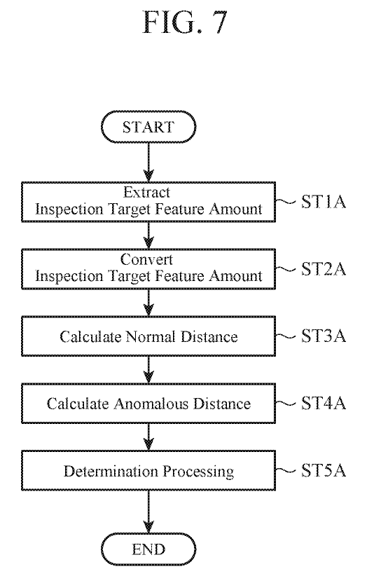

FIG. 7 is a flowchart illustrating inspection processing of the anomaly detection device 1 according to Embodiment 1, and illustrates the inspection processing of the inspection processing unit 12. The inspection processing is the anomaly detection method according to Embodiment 1.

The inspection target feature amount extraction unit 121 generates a first inspection target feature amount vector set including, as elements, feature amount vectors extracted from the inspection target image (step ST1A).

For example, the inspection target feature amount extraction unit 121 calculates the first inspection target feature amount vector set from the inspection target image obtained by photographing the inspection target object using the feature amount extractor B1.

The inspection target feature amount conversion unit 122 converts the first inspection target feature amount vector set into a second feature amount vector set (step ST2A). For example, the inspection target feature amount conversion unit 122 converts the first inspection target feature amount vector set per set element using the conversion processing matrix set read from the storage unit 13, and calculates the second inspection target feature amount vector set.

The normal distance calculation unit 123 calculates a normal distance per corresponding set element between the normal feature amount vector group set and the second inspection target feature amount vector set, and generates a normal distance set including normal distances as elements (step ST3A).

For example, the normal distance calculation unit 123 calculates a distance per set element between the second normal feature amount vector group set and the second inspection target feature amount vector set read from the storage unit 13, and calculates a normal distance set.

To calculate a normal distance, for example, an average vector of vectors and a covariance matrix are calculated from the second normal feature amount vector group, and a Mahalanobis distance between the second normal feature amount vector and the second inspection target feature amount vector is calculated.

The anomalous distance calculation unit 124 calculates an anomalous distance per corresponding set element between the anomalous feature amount vector group set and the second inspection target feature amount vector set, and generates an anomalous distance set including anomalous distances as elements (step ST4A). For example, the anomalous distance calculation unit 124 calculates a distance per set element between the second anomalous feature amount vector group set and the second inspection target feature amount vector set read from the storage unit 13, and calculates an anomalous distance set.

To calculate an anomalous distance, an inner product of an element of a lower-order Lth dimension of the second inspection target feature amount vector and an element of the lower-order Lth dimension of each second anomalous feature vector is calculated, and a value obtained by multiplying this inner product with “-1” is obtained as the anomalous distance. Furthermore, a shortest anomalous distance among anomalous distances between the individual second anomalous feature vectors is an anomalous distance of a corresponding second inspection target feature amount vector. It is experimentally confirmed that, by limiting elements to elements of the “lower- order Lth dimension”, performing an arithmetic operation on the inner product of the elements, and calculating the anomalous distance as described above, a correlation between an actual anomalous state and the anomalous distance is higher than in the case without such limitation.

The determination unit 125 determines whether each element of a set corresponding to the inspection target object image is normal or anomalous on the basis of the normal distance set and the anomalous distance set (step ST5A).

For example, the determination unit 125 calculates a set of normal/anomalous determination results by performing conditional determination on the normal distance set and the anomalous distance set per set element.

For example, a determination condition includes that only set elements satisfying both conditions that the normal distance is a first threshold or less and that the anomalous distance is a second threshold or more are determined as normal, and other set elements are determined as anomalous.

By learning and inspecting images as described above, it is possible to obtain the following effects.

The trained neural network is used to extract a feature amount, so that it is not necessary to train the neural network again per target object (effect 1).

Whether each partial region in an image is normal or anomalous is determined, so that it is possible to specify a position of an anomaly in the image (effect 2).

By using the conversion processing matrix of converting by singular value decomposition the first normal feature amount of the Pth dimension into the second normal feature amount of the Kth dimension where P ≥ K holds, it is possible to reduce a time required for appearance inspection by dimensionality reduction.

By using the conversion processing matrix of converting by singular value decomposition the first normal feature amount of the Pth dimension into the second normal feature amount of the Kth dimension where P ≥ K holds, it is possible to extract a feature amount well representing a feature of a normal object image and increase accuracy of appearance inspection.

A normal distance is calculated using a second feature amount of the Kth dimension well representing a feature of the normal object image, so that it is possible to perform a determination of normality accurately (effect 5).

The Kth dimension well representing the feature of the normal object image is extracted from the conversion processing matrix, so that, in an anomalous object image, a feature that is similar to the normal object image appears at a higher order of the Kth dimension and a feature that is not similar to the normal object image appears at a lower order of the Kth dimension. The lower-order Lth dimension in the Kth dimension of the second feature amount vector is used to calculate the anomalous distance, so that it is possible to accurately search for an inspection target image that is similar to the anomalous object image (effect 6).

Next, a hardware configuration that implements the functions of the anomaly detection device 1 will be described.

The learning processing unit 11, the inspection processing unit 12, and the storage unit 13 included in the anomaly detection device 1 are implemented by processing circuits. That is, the anomaly detection device 1 includes the processing circuits for executing processing in step ST1A to step ST5A illustrated in FIG. 7. The processing circuits may be dedicated hardware, yet may be Central Processing Units (CPUs) that execute programs stored in a memory.

FIG. 8A is a block diagram illustrating the hardware configuration that implements the functions of the anomaly detection device 1. FIG. 8B is a block diagram illustrating a hardware configuration that executes software that implements the functions of the anomaly detection device 1. In FIGS. 8A and 8B, an input interface 100 is an interface that relays image information to be output from an external device to the anomaly detection device 1. An output interface 101 is an interface that relays an anomalous inspection result to be output from the anomaly detection device 1 to the outside.

In a case where the processing circuit is a processing circuit 102 of the dedicated hardware illustrated in FIG. 8A, the processing circuit 102 corresponds to, for example, a single circuit, a composite circuit, a programmed processor, a parallel-programmed processor, an Application Specific Integrated Circuit (ASIC), a Field-Programmable Gate Array (FPGA), or a combination thereof. The functions of the learning processing unit 11, the inspection processing unit 12, and the storage unit 13 included in the anomaly detection device 1 may be implemented by different processing circuits, and these functions may be collectively implemented by one processing circuit.

In a case where the processing circuit is a processor 103 illustrated in FIG. 8B, the functions of the learning processing unit 11, the inspection processing unit 12, and the storage unit 13 included in the anomaly detection device 1 are implemented by software, firmware, or a combination of software and firmware. Note that the software or the firmware is described as programs, and stored in the memory 104. The memory 104 is, for example, the storage unit 13 illustrated in FIG. 1.

The processor 103 implements the functions of the learning processing unit 11, the inspection processing unit 12, and the storage unit 13 included in the anomaly detection device 1 by reading and executing the programs of an anomaly detection application stored in the memory 104. For example, the anomaly detection device 1 includes the memory 104 for storing the programs for eventually executing the processing in step ST1A to step ST5A illustrated in FIG. 7 when the processor 103 executes the programs. These programs cause a computer to execute a processing procedure or method performed by the learning processing unit 11, the inspection processing unit 12, and the storage unit 13.

The memory 104 may be a computer-readable storage medium having stored thereon the programs for causing the computer to function as the learning processing unit 11, the inspection processing unit 12, and the storage unit 13.

The memory 104 corresponds to, for example, a non-volatile or volatile semiconductor memory such as a Random Access Memory (RAM), a Read Only Memory (ROM), a flash memory, an Erasable Programmable Read Only Memory (EPROM), or an Electrically-EPROM (EEPROM), a magnetic disk, a flexible disk, an optical disk, a compact disk, a mini disk, a DVD, and the like.

Part of the functions of the learning processing unit 11, the inspection processing unit 12, and the storage unit 13 included in the anomaly detection device 1 may be implemented by dedicated hardware, and the rest of the functions may be implemented by software or firmware. For example, the function of the storage unit 13 is implemented by the processing circuit 102 that is the dedicated hardware, and the functions of the learning processing unit 11 and the inspection processing unit 12 may be implemented by the processor 103 reading and executing the programs stored in the memory 104.

Thus, the processing circuit can implement the above functions by hardware, software, firmware, or a combination thereof.

Although the case where the anomaly detection device 1 includes the learning processing unit 11 and the inspection processing unit 12 has been described above, the anomaly detection device 1 may include only the inspection processing unit 12. The learning processing unit 11 and the storage unit 13 may be included in a device separately provided from the anomaly detection device 1. In this case, the anomaly detection device 1 access these devices, and acquires a learning result.

As described above, the anomaly detection device 1 according to Embodiment 1 includes the inspection target feature amount extraction unit 121 that generates a first inspection target feature amount vector set including, as elements, first inspection target feature amount vectors extracted from an inspection target object image, the inspection target feature amount conversion unit 122 that converts the first inspection target feature amount vector set into a second inspection target feature amount vector set that is the same feature space as that of a feature amount vector set of an inspection target object in a normal state, the normal distance calculation unit 123 that calculates a normal distance per corresponding set element between the normal feature amount vector group set and the second inspection target feature amount vector set, and generates a normal distance set including normal distances as elements, the anomalous distance calculation unit 124 that calculates an anomalous distance per corresponding set element between an anomalous feature amount vector group set and the second inspection target feature amount vector set, and generates an anomalous distance set including anomalous distances as elements, and the determination unit 125 that determines whether each element of a set corresponding to the inspection target object image is normal or anomalous on the basis of the normal distance set and the anomalous distance set.

The elements of the set correspond to the partial regions of the image, and whether or not there is an anomaly can be determined per partial region of the image, so that the anomaly detection device 1 can specify at which position of an inspection target image obtained by photographing an inspection target object an anomaly is occurring.

The anomaly detection device 1 according to Embodiment 1 includes the normal feature amount extraction unit 111 that extracts a first normal feature amount vector group set from a plurality of normal object images, the conversion processing matrix generation unit 112 that calculates a conversion processing matrix of the feature space using the first normal feature amount vector group set per partial region of the normal object image, and generates a conversion processing matrix set including a plurality of the conversion processing matrices as elements, the normal feature amount conversion unit 113 that performs conversion using the conversion processing matrix set into a normal feature amount vector set that is the same feature space as that of the first normal feature amount vector group set and is used to calculate the normal distance, the anomalous feature amount extraction unit 114 that acquires an anomalous object image group including a plurality of the anomalous object images as elements, and extracts a first anomalous feature amount vector group set obtained by collecting for all of partial regions the plurality of anomalous feature amount vector groups calculated for the partial regions at an identical position in all of the anomalous object images among the plurality of partial regions partitioning the anomalous object image, and the anomalous feature amount conversion unit 115 that performs conversion using the conversion processing matrix set into an anomalous feature amount vector set that is the same feature space as that of the first anomalous feature amount vector group set and is used to calculate the anomalous distance. Consequently, the anomaly detection device 1 can learn extraction of feature amount vectors and calculation of a conversion processing matrix that are necessary to detect an anomaly of an inspection target object.

In the anomaly detection device 1 according to Embodiment 1, the inspection target feature amount extraction unit 121 is a trained neural network that outputs the first inspection target feature amount vector set when receiving an input of an image. By using the above trained neural network, the inspection target feature amount extraction unit 121 can accurately extract the first inspection target feature amount vector set from the image.

In the anomaly detection device 1 according to Embodiment 1, one or both of the normal feature amount extraction unit 111 and the anomalous feature amount extraction unit 114 are trained neural networks that output feature amount vector sets representing a feature of a region per partial region obtained by partitioning the image into a plurality of regions when receiving an input of the image. By using the trained neural network, the normal feature amount extraction unit 111 can accurately extract the normal feature amount vector set from the normal image. By using the trained neural network, the anomalous feature amount extraction unit 114 can accurately extract the anomalous feature amount vector set from the anomalous image.

In the anomaly detection device 1 according to Embodiment 1, the inspection target feature amount conversion unit 122 converts using the conversion processing matrix set the first feature amount vector set into the second feature amount vector set that is the same feature space as that of the feature amount vector set of the inspection target object in the normal state per partial region. Consequently, the inspection target feature amount conversion unit 122 can accurately convert the first inspection target feature amount vector set into the second feature amount vector set per partial region.

In the anomaly detection device 1 according to Embodiment 1, the conversion processing matrix generation unit 112 calculates a conversion processing matrix by performing singular value decomposition on the first normal feature amount vector group that is an element of the first normal feature amount vector group set. By using this conversion processing matrix, the conversion processing matrix generation unit 112 can accurately convert the first inspection target feature amount vector set into the second inspection target feature amount vector set that is the same feature space as that of the feature amount vector set of an inspection target object in the normal state.

In the anomaly detection device 1 according to Embodiment 1, the normal distance calculation unit 123 calculates a Mahalanobis distance or an Euclidean distance as the normal distance per corresponding set element between the normal feature amount vector group set and the second inspection target feature amount vector set. Consequently, the normal distance calculation unit 123 can accurately calculate the normal distance.

In the anomaly detection device 1 according to Embodiment 1, the anomalous distance calculation unit 124 calculates an inner product of an element of a lower-order Lth dimension of the second inspection target feature amount vector that is the element of the second inspection target feature amount vector set, and an element of the lower-order Lth dimension of the anomalous feature amount vector that is the element of the anomalous feature amount vector group set, and calculates a value obtained by multiplying a value of the inner product with -1 as the anomalous distance. Consequently, the normal distance calculation unit 123 can accurately calculate the anomalous distance.

In the anomaly detection device 1 according to Embodiment 1, when the normal distance is the first threshold or less and the anomalous distance is the second threshold or more, the determination unit 125 determines that the inspection target object is in the normal state. Consequently, the determination unit 125 can determine whether or not the inspection target object is in the normal state per partial region of the image.

In the anomaly detection device 1 according to Embodiment 1, when the normal distance is the first threshold or more and the anomalous distance is the second threshold or less, the determination unit 125 determines that the inspection target object is in the anomalous state. Consequently, the determination unit 125 can determine whether or not the inspection target object is in the anomalous state per partial region of the image.

The anomaly detection method according to Embodiment 1 includes step ST1A of, by the inspection target feature amount extraction unit 121, generating a first inspection target feature amount vector set including, as elements, feature amount vectors extracted from the inspection target object image, step ST2A of, by the inspection target feature amount conversion unit 122, converting the first inspection target feature amount vector set into a second feature amount vector set, step ST3A of, by the normal distance calculation unit 123, calculating a normal distance per corresponding set element between a normal feature amount vector group set and a second inspection target feature amount vector set, and generating a normal distance set, step ST4A of, by the anomalous distance calculation unit 124, calculating an anomalous distance per corresponding set element between an anomalous feature amount vector group set and the second inspection target feature amount vector set, and generating an anomalous distance set, and step ST5A of, by the determination unit 125, determining whether each element of a set corresponding to the inspection target object image is normal or anomalous on the basis of the normal distance set and the anomalous distance set. By executing this method, the anomaly detection device 1 can specify at which position of an inspection target image an anomaly is occurring.

The anomaly detection method according to Embodiment 1 includes step ST1 of, by the normal feature amount extraction unit 111, extracting a first normal feature amount vector group set obtained by collecting a plurality of normal feature amount vector groups for all of partial regions, step ST2 of, by the conversion processing matrix generation unit 112, calculating a conversion processing matrix of feature space using the first normal feature amount vector group set per partial region of the normal object image, and generating a conversion processing matrix set including a plurality of the conversion processing matrices as elements, step ST3 of, by the normal feature amount conversion unit 113, performing conversion using the conversion processing matrix set into a normal feature amount vector set that is the same feature space as that of the first normal feature amount vector group set and is used to calculate a normal distance, step ST4 of, by the anomalous feature amount extraction unit 114, extracting the first anomalous feature amount vector group set obtained by collecting a plurality of anomalous feature amount vector groups for all of partial regions, and step ST5 of, by the anomalous feature amount conversion unit 115, performing conversion using the conversion processing matrix set into an anomalous feature amount vector set that is the same feature space as that of the first anomalous feature amount vector group set and is used to calculate an anomalous distance. By executing this method, the anomaly detection device 1 can learn extraction of feature amount vectors and calculation of a conversion processing matrix that are necessary to detect an anomaly of an inspection target object.

Note that it is possible to modify arbitrary components in the embodiment, or omit arbitrary components in the embodiment.

### INDUSTRIAL APPLICABILITY

The anomaly detection device according to the present disclosure can be used to, for example, inspect appearances of products on a production line.

### REFERENCE SIGNS LIST

1: anomaly detection device, 11: learning processing unit, 12: inspection processing unit, 13: storage unit, 100: input interface, 101: output interface, 102: processing circuit, 103: processor, 104: memory, 111: normal feature amount extraction unit, 112: conversion processing matrix generation unit, 113: normal feature amount conversion unit, 114: anomalous feature amount extraction unit, 115: anomalous feature amount conversion unit, 121: inspection target feature amount extraction unit, 122: inspection target feature amount conversion unit, 123: normal distance calculation unit, 124: anomalous distance calculation unit, 125: determination unit

1. An anomaly detection device comprising:
processing circuitry
to extract a first inspection target feature amount vector of each of a plurality of partial regions, and generate a first inspection target feature amount vector set including the first inspection target feature amount vector as an element, the plurality of partial regions partitioning an inspection target object image obtained by photographing an inspection target object;
to convert the first inspection target feature amount vector set into a second inspection target feature amount vector set that is same feature space as feature space of a feature amount vector set of an inspection target object in a normal state;
to calculate a normal distance per corresponding set element between a normal feature amount vector group set and the second inspection target feature amount vector set, and generate a normal distance set including a normal distance as an element, the normal feature amount vector group set being obtained by collecting a plurality of normal feature amount vector groups for all partial regions, and the plurality of normal feature amount vector groups being calculated for partial regions at an identical position in all normal object images among a plurality of partial regions partitioning a normal object image obtained by photographing the inspection target object in the normal state;
to calculate an anomalous distance per corresponding set element between an anomalous feature amount vector group set and the second inspection target feature amount vector set, and generate an anomalous distance set including an anomalous distance as an element, the anomalous feature amount vector group set being obtained by collecting a plurality of anomalous feature amount vector groups for all partial regions, and the plurality of anomalous feature amount vector groups being calculated for partial regions at an identical position in all anomalous object images among a plurality of partial regions partitioning an anomalous object image obtained by photographing an inspection target object in an anomalous state;
to determine whether each element of a set corresponding to the inspection target object image is normal or anomalous on a basis of the normal distance set and the anomalous distance set;
to acquire a normal object image group, and extract a first normal feature amount vector group set, the normal object image group including a plurality of the normal object images as elements, and the first normal feature amount vector group set being obtained by collecting for all of the partial regions the plurality of normal feature amount vector groups calculated for the partial regions at the identical position in all of the normal object images among the plurality of partial regions partitioning the normal object image;
to calculate a conversion processing matrix of the feature space using the first normal feature amount vector group set per partial region of the normal object image, and generate a conversion processing matrix set including a plurality of the conversion processing matrices as elements;
to perform conversion using the conversion processing matrix set into a normal feature amount vector set that is same feature space as feature space of the first normal feature amount vector group set and is used to calculate the normal distance;
to acquire an anomalous object image group, and extract a first anomalous feature amount vector group set, the anomalous object image group including a plurality of the anomalous object images as elements, and the first anomalous feature amount vector group set being obtained by collecting for all of the partial regions the plurality of anomalous feature amount vector groups calculated for the partial regions at the identical position in all of the anomalous object images among the plurality of partial regions partitioning the anomalous object image; and
to perform conversion using the conversion processing matrix set into an anomalous feature amount vector set that is same feature space as feature space of the first anomalous feature amount vector group set and is used to calculate the anomalous distance.

2. The anomaly detection device according to claim 1, wherein the processing circuitry comprises a trained neural network that outputs the first inspection target feature amount vector set when receiving an input of an image.

3. The anomaly detection device according to claim 1, wherein processing circuitry comprises a trained neural network that outputs a feature amount vector set representing a feature of a region per partial region obtained by partitioning an image into a plurality of regions when receiving an input of the image.

4. The anomaly detection device according to claim 1, wherein the processing circuitry converts using a conversion processing matrix set the first inspection target feature amount vector set into the second inspection target feature amount vector set that is the same feature space as the feature space of the feature amount vector set of the inspection target object in the normal state per partial region.

5. The anomaly detection device according to claim 1, wherein the processing circuitry calculates the conversion processing matrix by performing singular value decomposition on the first normal feature amount vector group that is an element of the first normal feature amount vector group set.

6. The anomaly detection device according to claim 1, wherein the processing circuitry calculates a Mahalanobis distance or an Euclidean distance as the normal distance per corresponding set element between the normal feature amount vector group set and the second inspection target feature amount vector set.

7. The anomaly detection device according to claim 2, wherein the processing circuitry calculates a Mahalanobis distance or an Euclidean distance as the normal distance per corresponding set element between the normal feature amount vector group set and the second inspection target feature amount vector set.

8. The anomaly detection device according to claim 3, wherein the processing circuitry calculates a Mahalanobis distance or an Euclidean distance as the normal distance per corresponding set element between the normal feature amount vector group set and the second inspection target feature amount vector set.

9. The anomaly detection device according to claim 4, wherein the processing circuitry calculates a Mahalanobis distance or an Euclidean distance as the normal distance per corresponding set element between the normal feature amount vector group set and the second inspection target feature amount vector set.

10. The anomaly detection device according to claim 5, wherein the processing circuitry calculates a Mahalanobis distance or an Euclidean distance as the normal distance per corresponding set element between the normal feature amount vector group set and the second inspection target feature amount vector set.

11. The anomaly detection device according to claim 1, wherein the processing circuitry calculates an inner product of an element of a lower-order Lth dimension of the second inspection target feature amount vector and an element of the lower-order Lth dimension of the anomalous feature amount vector, and calculates a value obtained by multiplying a value of the inner product with -1 as the anomalous distance, the element of the lower-order Lth dimension of the second inspection target feature amount vector being the element of the second inspection target feature amount vector set, and the element of the lower-order Lth dimension of the anomalous feature amount vector being the element of the anomalous feature amount vector group set.

12. The anomaly detection device according to claim 2, wherein the processing circuitry calculates an inner product of an element of a lower-order Lth dimension of the second inspection target feature amount vector and an element of the lower-order Lth dimension of the anomalous feature amount vector, and calculates a value obtained by multiplying a value of the inner product with -1 as the anomalous distance, the element of the lower-order Lth dimension of the second inspection target feature amount vector being the element of the second inspection target feature amount vector set, and the element of the lower-order Lth dimension of the anomalous feature amount vector being the element of the anomalous feature amount vector group set.

13. The anomaly detection device according to claim 3, wherein the processing circuitry calculates an inner product of an element of a lower-order Lth dimension of the second inspection target feature amount vector and an element of the lower-order Lth dimension of the anomalous feature amount vector, and calculates a value obtained by multiplying a value of the inner product with -1 as the anomalous distance, the element of the lower-order Lth dimension of the second inspection target feature amount vector being the element of the second inspection target feature amount vector set, and the element of the lower-order Lth dimension of the anomalous feature amount vector being the element of the anomalous feature amount vector group set.

14. The anomaly detection device according to claim 4, wherein the processing circuitry calculates an inner product of an element of a lower-order Lth dimension of the second inspection target feature amount vector and an element of the lower-order Lth dimension of the anomalous feature amount vector, and calculates a value obtained by multiplying a value of the inner product with -1 as the anomalous distance, the element of the lower-order Lth dimension of the second inspection target feature amount vector being the element of the second inspection target feature amount vector set, and the element of the lower-order Lth dimension of the anomalous feature amount vector being the element of the anomalous feature amount vector group set.

15. The anomaly detection device according to claim 5, wherein the processing circuitry calculates an inner product of an element of a lower-order Lth dimension of the second inspection target feature amount vector and an element of the lower-order Lth dimension of the anomalous feature amount vector, and calculates a value obtained by multiplying a value of the inner product with -1 as the anomalous distance, the element of the lower-order Lth dimension of the second inspection target feature amount vector being the element of the second inspection target feature amount vector set, and the element of the lower-order Lth dimension of the anomalous feature amount vector being the element of the anomalous feature amount vector group set.

16. The anomaly detection device according to claim 6, wherein the processing circuitry calculates an inner product of an element of a lower-order Lth dimension of the second inspection target feature amount vector and an element of the lower-order Lth dimension of the anomalous feature amount vector, and calculates a value obtained by multiplying a value of the inner product with -1 as the anomalous distance, the element of the lower-order Lth dimension of the second inspection target feature amount vector being the element of the second inspection target feature amount vector set, and the element of the lower-order Lth dimension of the anomalous feature amount vector being the element of the anomalous feature amount vector group set.

17. The anomaly detection device according to claim 1, wherein, when the normal distance is a first threshold or less and the anomalous distance is a second threshold or more, the processing circuitry determines that the inspection target object is in the normal state.

18. The anomaly detection device according to claim 1, wherein, when the normal distance is a first threshold or more and the anomalous distance is a second threshold or less, the processing circuitry determines that the inspection target object is in the anomalous state.

19. An anomaly detection method of an anomaly detection device comprising:
extracting a first inspection target feature amount vector of each of a plurality of partial regions, to generate a first inspection target feature amount vector set including the first inspection target feature amount vector as an element, the plurality of partial regions partitioning an inspection target object image obtained by photographing an inspection target object;
converting the first inspection target feature amount vector set into a second inspection target feature amount vector set that is same feature space as feature space of a feature amount vector set of an inspection target object in a normal state;
calculating a normal distance per corresponding set element between a normal feature amount vector group set and the second inspection target feature amount vector set, and generating a normal distance set including a normal distance as an element, the normal feature amount vector group set being obtained by collecting a plurality of normal feature amount vector groups for all partial regions, and the plurality of normal feature amount vector groups being calculated for partial regions at an identical position in all of the normal object images among a plurality of partial regions partitioning a normal object image obtained by photographing the inspection target object in the normal state;
calculating an anomalous distance per corresponding set element between an anomalous feature amount vector group set and the second inspection target feature amount vector set, and generating an anomalous distance set including an anomalous distance as an element, the anomalous feature amount vector group set being obtained by collecting a plurality of anomalous feature amount vector groups for all partial regions, and the plurality of anomalous feature amount vector groups being calculated for partial regions at an identical position in all anomalous object images among a plurality of partial regions partitioning an anomalous object image obtained by photographing an inspection target object in an anomalous state;
determining whether each element of a set corresponding to the inspection target object image is normal or anomalous on a basis of the normal distance set and the anomalous distance set;
acquiring a normal object image group, to extract a first normal feature amount vector group set, the normal object image group including a plurality of the normal object images as elements, and the first normal feature amount vector group set being obtained by collecting for all of the partial regions the plurality of normal feature amount vector groups calculated for the partial regions at the identical position in all of the normal object images among the plurality of partial regions partitioning the normal object image;
calculating a conversion processing matrix of the feature space using the first normal feature amount vector group set per partial region of the normal object image, to generate a conversion processing matrix set including a plurality of the conversion processing matrices as elements;
performing conversion using the conversion processing matrix set into a normal feature amount vector set that is same feature space as feature space of the first normal feature amount vector group set and is used to calculate the normal distance;
acquiring an anomalous object image group to extract a first anomalous feature amount vector group set, the anomalous object image group including a plurality of the anomalous object images as elements, and the first anomalous feature amount vector group set being obtained by collecting for all of the partial regions the plurality of anomalous feature amount vector groups calculated for the partial regions at the identical position in all of the anomalous object images among the plurality of partial regions partitioning the anomalous object image; and
performing conversion using the conversion processing matrix set into an anomalous feature amount vector set that is same feature space as feature space of the first anomalous feature amount vector group set and is used to calculate the anomalous distance.
